(19) United States
(12) Patent Application Publication
(10) Pub. No.: US 2026/0089627 A1
(43) Pub. Date: Mar. 26, 2026

(54) WIRELESS COMMUNICATION SYSTEM AND METHOD FOR CONTROLLING WIRELESS COMMUNICATION SYSTEM

(71) Applicant: DENSO CORPORATION, Kariya-city (JP)

(72) Inventors: SHO MATSUMOTO, Kariya-city (JP); TATSUHIRO NUMATA, Kariya-city (JP); MASAHIRO SUGIURA, Kariya-city (JP); MASAHIRO FUKUDA, Kariya-city (JP); KOHKI OHBA, Kariya-city (JP)

(21) Appl. No.: 19/266,662

(22) Filed: Jul. 11, 2025

(30) Foreign Application Priority Data
Sep. 23, 2024 (JP) 2024-164678

(51) Int. Cl. H04W 52/02; H04W 4/40

(52) U.S. Cl. CPC H04W 52/0216; H04W 4/40

(57) ABSTRACT

An application system requires data at each system period. A slave node transmits the data to a master node. The master node and the slave node execute bidirectional wireless communication multiple times within the system period. When the application system has successfully acquired the data in a predetermined number of the multiple times of the bidirectional wireless communication, the master node transmits success information to the slave node. In response to receiving the success information, the slave node stops a remaining number of the multiple times of the bidirectional wireless communication.

### CROSS REFERENCE TO RELATED APPLICATION

The present application claims the benefit of priority from Japanese Patent Application No. 2024-164678 filed on Sep. 23, 2024. The entire disclosure of the above application is incorporated herein by reference.

### TECHNICAL FIELD

The present disclosure relates to a wireless communication system used for a specific application system to acquire necessary data, and a method for controlling the wireless communication system.

### BACKGROUND

For example, a conceivable technique teaches a technique for reducing the power consumption of a communication system that operates with a finite power supply. In the communication system according to Patent Literature 1, the sleep control unit of the access point estimates the remaining amount of the storage battery after BLE communication by subtracting a unit power amount, which is the amount of power required for one BLE communication, from the remaining amount of the storage battery of the access point. The sleep control unit refers to the correspondence table based on the estimated remaining amount, and calculates the charging time required for the estimated remaining amount of the storage battery to increase to the unit amount of power. The correspondence table shows the remaining amount of the storage battery when the storage battery is charged for various charging times based on various estimated remaining amount. The sleep control unit determines the calculated charging time as the shortest sleep period.

The access point transitions to a sleep state for the determined shortest sleep period and charges the storage battery. Thus, the access point can be returned from the sleep state in a state in which the access point can execute at least one BLE communication. In addition, the access point transmits the communication signal of the BLE communication including the information about the determined shortest sleep period to the wireless terminal. The wireless terminal transitions to a sleep state for the shortest sleep period received. In this way, the wireless terminal also transitions to a sleep state for the shortest sleep period, so that power consumption in the wireless terminal can also be reduced.

### SUMMARY

According to an example, an application system requires data at each system period. A slave node transmits the data to a master node. The master node and the slave node execute bidirectional wireless communication multiple times within the system period. When the application system has successfully acquired the data in a predetermined number of the multiple times of the bidirectional wireless communication, the master node transmits success information to the slave node. In response to receiving the success information, the slave node stops a remaining number of the multiple times of the bidirectional wireless communication.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an example of the configuration of an in-vehicle system that has a plurality of application systems that operate using a wireless communication system;

FIG. 2 is a schematic diagram showing the software and hardware configuration of various application systems;

FIG. 3 is a diagram showing an example of the relationship between a system period and a communication period of wireless communication between a master device and a slave device;

FIG. 4 is a flowchart showing an example of a process executed in an application system including a wireless communication system;

FIG. 5 is a flowchart showing an example of a process of forming a transmission frame in the flowchart of FIG. 4;

FIG. 6 is a diagram showing an example of a transmission frame;

FIG. 7 is a flowchart showing an example of a process of determining whether a standby operation is available in the flowchart of FIG. 4;

FIG. 8 is a flowchart showing an example of a process for transmitting to the master side when an application on the slave side detects an anomaly; and

FIG. 9 is a diagram showing an example in which a slave-side communication software and hardware is instructed to enter one of a standby state, a sleep state, and a deep sleep state depending on the number of times of remaining period.

### DETAILED DESCRIPTION

As described above, the communication system described in the conceivable technique determines the shortest sleep period based on the remaining amount of the storage battery in the access point, and the access point and the wireless terminal are in a sleep state for the shortest sleep period.

Here, a wireless communication system may be used to acquire the data required by a specific application system. In this case, the wireless communication system includes a master node and at least one slave node, and the data can be transmitted from the slave node to the master node. In addition, the application system may be required to acquire the latest data value via wireless communication between the master node and slave node at each specific system period in order to execute monitoring, warning, or other processing depending on the situation at that time.

However, when the technique of the communication system described in the conceivable technique is used to reduce power consumption in a wireless communication system while a specific application system acquires necessary data, the sleep period is determined based on the remaining amount of the storage battery, so there may be a risk that the application system will not be able to acquire the latest data value at each specific system period.

The present disclosure has been made in consideration of the above-described points, and aims to provide a wireless communication system and a method for controlling a wireless communication system that, when an application system uses a wireless communication system to acquire necessary data, the application system can acquire the latest value of data at each predetermined system period while reducing power consumption.

In order to achieve the above described object, a wireless communication system according to the present embodiments is used for a predetermined application system to acquire necessary data.

The wireless communication system includes: at least one master node; and at least one slave node. The master node and the slave node execute bidirectional wireless communication. The slave node transmits data to the master node. The predetermined application system is required to acquire a latest value of the data at each predetermined system period. The master node and the slave node are configured to execute the two-way wireless communication a plurality of times within a predetermined system period. When the application system has successfully acquired the data in a predetermined number of wireless communications, the master node transmits success information to the slave node. In response to receiving the success information, the slave node stops remaining wireless communications of the predetermined number of wireless communications.

A method for controlling a wireless communication system according to the present embodiments is used for a predetermined application system to acquire necessary data. The wireless communication system includes at least one master node and at least one slave node. The master node and the slave node execute bidirectional wireless communication. The slave node transmits data to the master node. The predetermined application system is required to acquire a latest value of the data at each predetermined system period. The master node and the slave node are configured to execute the two-way wireless communication a plurality of times within a predetermined system period. When the application system has successfully acquired the data in a predetermined number of wireless communications, the master node transmits success information to the slave node. In response to receiving the success information, the slave node stops remaining wireless communications of the predetermined number of wireless communications.

According to the wireless communication system and the method for controlling the wireless communication system of the present embodiments, the master node and the slave node are configured to execute the wireless communication a plurality of times within a predetermined system period. Although the wireless communication may be more likely to generate a communication error than the wired communication, the application system can increase the probability to acquire the latest value of the data at each system period using the plurality of wireless communications.

According to the wireless communication system and the method for controlling the wireless communication system in the present embodiments, when the application system has successfully acquired the data in a predetermined number of wireless communications, the master node transmits success information to the slave node. In response to receiving the success information, the slave node stops remaining wireless communications of the predetermined number of wireless communications. Thus, the application system can acquire the latest value of the data at each predetermined system period, while reducing the power consumption in the slave node.

The reference signs and/or numerals in parentheses are merely added to indicate examples of correspondence relationships with concrete structures in the below-described embodiments in order to facilitate the understanding of the present disclosure, which has no intention to limit the scope of the present disclosure in any manner.

Technical features described in the following sections other than the above-mentioned features become apparent from the description of the embodiments and the accompanying drawings.

Hereinafter, preferred embodiments of the present disclosure will be described with reference to the drawings. Note that the same or similar components are denoted by the same reference symbols throughout multiple drawings, and description thereof may be omitted. When only a part of a configuration is described in each embodiment, the configurations of other embodiments previously described can be applied to the other parts of the configuration. In addition, not only a combination of configurations explicitly specified in the description of each embodiment but also configurations of a plurality of embodiments can be partially combined even if not explicitly specified as long as there is no problem in the combination.

### First Embodiment

The wireless communication system according to this embodiment includes at least one master device (also referred to as a master node) and at least one slave device (also referred to as a slave node). At least one of the master device and the slave device may be used while being mounted on a vehicle. In this case, at least the slave device may operate using power supplied from the battery. The vehicle includes, for example, an automobile, a truck, a construction vehicle, a motorcycle, a railroad car, and the like.

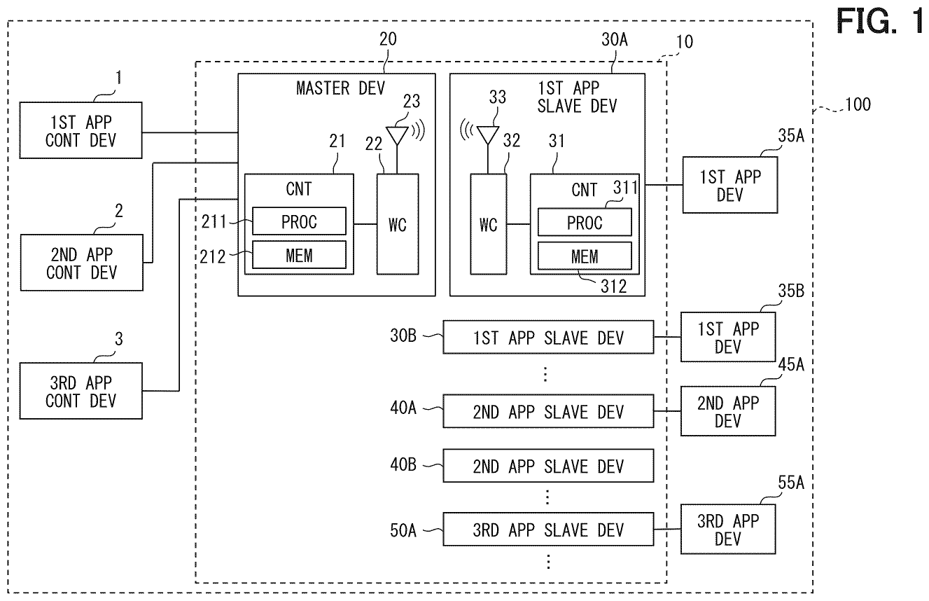

FIG. 1 is a diagram showing an example of the configuration of an in-vehicle system 100 that has a plurality of application systems that operate using a wireless communication system 10. As shown in FIG. 1, in an in-vehicle system 100, a wireless communication system 10 can be applied to various application systems. In this case, each of the plurality of slave devices 30A, 30B, 40A, 40B, and 50A is associated with one of the application systems.

For example, the wireless communication system 10 is applied to, as one of application systems, a battery monitoring system that monitors a state of a battery mounted as a battery pack (i.e., assembled battery) in an electrified vehicle, such as, an electric vehicle, a hybrid vehicle, and a plug-in hybrid vehicle and the like. When the wireless communication system 10 is applied to a battery monitoring system, for example, at least one master device 20 is connected to a first application control device 1 having a function as a monitoring control device. A plurality of first application slave devices 30A, 30B are provided in a plurality of battery stacks constituting the battery pack, respectively, and are connected to the first application devices 35A, 35B having a function as a detection device. In this case, the first application slave devices 30A, 30B operate using power supplied from the corresponding battery stacks, respectively. Further, both the master device 20 and the multiple first application slave devices 30A, 30B are mounted on the vehicle.

Each detection device (i.e., each first application device 35A, 35B) provided for each of the plurality of battery stacks detects battery information such as the voltage and current of each battery cell included in the corresponding battery stack and the temperature of the battery stack using various sensors and the like. Then, in response to receiving a packet for requesting the battery information from the first application control device 1, which is a monitoring control device, via the wireless communication system 10, the first application device 35A, 35B transmits a packet including the detected battery information to the first application control device 1 via the wireless communication system 10.

The first application control device 1 calculates the state of charge (i.e., SOC) of the entire battery stack based on the received battery information, and determines whether to execute the driving of the temperature raising and cooling mechanism and whether to execute the equalization process for equalizing the voltage of each battery cell in the battery stack in order to adjust the temperature of the battery pack within an appropriate range. For example, the first application control device 1 can instruct the corresponding first application device 35A, 35B to execute the equalization process via the wireless communication system 10 when a determination is made that it is necessary to execute the equalization process on at least one battery stack. In addition, each first application device 35A, 35B executes a process to determine anomaly in various sensors and anomaly in the own operation, and if an anomaly is determined, the first application device 35A, 35B transmits anomaly information to the first application control device 1 via the wireless communication system 10.

Moreover, the wireless communication system 10 according to the present embodiment can be applied to other application systems such as a smart key (registered trademark, the same applies below) system and a tire pressure monitoring system. When the wireless communication system 10 is applied to the vehicle smart key system, for example, the master device 20 is mounted on the vehicle and is connected to a second application control device 2 that has a function as an in-vehicle unit for controlling the lock and unlock of a vehicle door and turn on and off of a drive source such as an engine of the vehicle. The second application slave device 40A is mounted on an electronic key which is a second application device 45A. In this case, the second application slave device 40A operates using power supplied from the battery built in the electronic key, for example.

When the second application device 45A receives the request signal from the second application control device 2, the second application device 45A returns a response signal via the second application slave device 40A. In a smart key system, this response signal provides the data necessary for the application system. The second application control device 2 can estimate the distance to the electronic key based on this response signal.

Furthermore, a plurality of other second application slave devices 40B may be disposed at various locations of the vehicle, such as at the front portion, a side portion, a rear portion and the like. A plurality of second application slave devices 40B arranged in various locations in the vehicle have the function of, for example, intercepting communication between the master device 20 and a second application slave device 40A mounted on an electronic key, and transmitting the results of the intercepted communication to the master device 20. The second application slave devices 40B may be connected to the master device 20 by wire. The second application control device 2 can detect the position of the electronic key with high accuracy using position determination techniques such as multilateral measurements or polygonal measurements based on the positions of the multiple second application slave devices 40B, the time when the multiple second application slave devices 40B intercepted communications, and/or the angle of arrival of the communication signal at the multiple second application slave devices 40B.

When the wireless communication system 10 is applied to a tire pressure monitoring system, the master device 20 is mounted on the vehicle and connected to a third application control device 3 that has a function as a monitoring unit for issuing a warning or the like when tire air pressure is in the anomaly state or a display of the tire air pressure is in the anomaly state. A plurality of third application slave devices 50A are connected by wire or wirelessly to a air pressure detection device (a third application device 55A) provided in the respective tires. In this case, the plurality of third application slave device 50A operate using power supplied from the battery built in the own device, for example. Then, the air pressure detected by the third application device 55A is transmitted to the third application control device 3 via the wireless communication system 10 in response to a data request command from the third application control device 3. The third application control device 3 can display the tire pressure and issue a warning if the tire pressure is in the anomaly state, based on the received tire pressure.

It should be noted that the configuration shown in FIG. 1 is merely an example of the present embodiments. For example, the in-vehicle system 100 according to the present embodiments does not need to be equipped with all of the application systems of the battery monitoring system, the smart key system, and the tire pressure monitoring system, and may be configured to have at least one application system. In the configuration shown in FIG. 1, the wireless communication system 10 including one master device 20 and multiple slave devices 30A, 30B, 40A, and 50A is provided for multiple application systems. Alternatively, the wireless communication system 10 may include a plurality of master devices 20. When multiple master devices 20 are provided, the multiple master devices 20 may communicate with different slave devices 30A, 30B, 40A, 50A for each application system, for example. Alternatively, multiple master devices 20 may communicate with the same multiple slave devices 30A, 30B, 40A, 50A for each application system. Furthermore, in the configuration shown in FIG. 1, the control devices 1, 2, and 3 of the multiple application systems are provided separately, alternatively, the functions of two or more control devices may be integrated into one control device.

In the following, a configuration of a wireless communication system 10 applied to a battery monitoring system, which is one of the application systems, will be described. The wireless communication system 10 applied to other application systems may be configured in a similar manner.

A wireless communication system 10 applied to a battery monitoring system includes a master device 20 and first application slave devices 30A and 30B. The master device 20 and the first application slave devices 30A, 30B can execute wireless communication according to, for example, the Bluetooth Low Energy (here, Bluetooth is a registered trademark, and the same applies below, and hereinafter Bluetooth Low Energy will be abbreviated as Bluetooth LE) communication standard. when executing the wireless communication according to the Bluetooth LE communication standards, details of the communication method related to communication connection, encrypted communication, and the like are performed according to the sequence defined by the Bluetooth LE standard. Here, the master device 20 and the first application slave devices 30A, 30B may execute the wireless communication in accordance with other wireless communication standards, such as ultra-wideband (i.e., UWB) wireless communication or Wi-Fi (registered trademark) wireless communication.

The master device 20 includes a control circuit (i.e., CNT) 21, a wireless communication circuit (i.e., WC) 22, and an antenna 23, as shown in FIG. 1. In addition to the above-described elements, the master device 20 may include an input-output interface and a bus line for wired or wireless communication with devices other than the first application slave devices 30A, 30B.

The control circuit 21 is, for example, a computer including a processor 211 and a memory 212. The memory 212 includes, for example, RAM and ROM. The RAM is an abbreviation for Random Access Memory. The ROM is an abbreviation for Read Only Memory. In the control circuit 21, the processor 211 executes programs stored in the ROM while using the RAM as a temporary storage area, thereby executing software processing related to the wireless communication, such as connection establishment processing between the master device 20 and the first application slave devices 30A, 30B, encryption processing, and decryption processing. The number of processors 211 may be one or multiple. The program storage medium is not limited to the ROM. For example, various storage media such as HDD and SSD can be adopted. The HDD is an abbreviation for Hard-Disk Drive. SSD is an abbreviation for Solid State Drive.

The processor 211 is, for example, a CPU, a MPU, a GPU, a DFP, or the like. CPU is an abbreviation for Central Processing Unit. MPU is an abbreviation for Micro-Processing Unit. GPU is an abbreviation for Graphics Processing Unit. DFP is an abbreviation for Data Flow Processor. The control circuit 21 may be implemented by combining multiple types of calculation processing units such as a CPU, an MPU, and a GPU. Alternatively, the control circuit 21 may be realized as an SoC. The SoC is an abbreviation for System on Chip. The control circuit 21 may be realized using ASIC or FPGA. ASIC is an abbreviation for Application Specific Integrated Circuit. The FPGA is an abbreviation for Field-Programmable Gate Array.

The wireless communication circuit 22 includes a RF circuit (not shown) for wirelessly transmitting and receiving the packet. The wireless communication circuit 22 has a transmission function of modulating a transmission signal and oscillating the signal at the frequency of an RF signal. The wireless communication circuit 22 has a receiving function of demodulating the received signal. RF is an abbreviation for radio frequency.

More specifically, the wireless communication circuit 22 modulates a packet including the data output from the control circuit 21 and transmits the packet to the first application slave devices 30A and 30B via the antenna 23 by the RF circuit. The control circuit 21 outputs, to the wireless communication circuit 22, the packet including a request command and the like which is encrypted using, for example, encryption information exchanged in a connection establishment process. By executing the encryption process, the confidentiality of the data can be improved. Here, the connection establishment process and/or the encryption process may not be executed. For example, the control circuit 21 of the master device 20 may synchronize the communication timing for communicating with the first application slave devices 30A and 30B and executes transmission and reception at that communication timing. Furthermore, the master device may transmit a packet including data such as a request command without executing the encryption process.

The wireless communication circuit 22 can add data (for example, communication control information) necessary for the wireless communication, to the transmission packet. The data necessary for the wireless communication includes, for example, an identifier (ID), a sequence number, a next sequence number, an error detection code, and the like. The wireless communication circuit 22 may control data size, communication format, schedule, error detection, or the like of communication between the master device 20 and the first application slave devices 30A and 30B. The control related to these communications may be performed by the control circuit 21.

Here, the wireless communication circuit 22 receives via the antenna 23 and modulates a packet including the data output from the first application slave devices 30A and 30B. The demodulated packet is transmitted to the control circuit 21. The control circuit 21 can extract data from the demodulated packet by executing a decoding process and the like. The antenna 23 converts electrical signals into radio waves and radiates the radio waves into space. The antenna 23 receives a electric wave propagating in space and converts the electric wave into an electric signal.

Each of the first application slave devices 30A, 30B has the same configuration. Therefore, the configuration, operation, and the like of the first application slave device 30A will be described below as a representative example.

The first application slave device 30A includes a control circuit (i.e., CNT) 31, a wireless communication circuit (i.e., WC) 32, and an antenna 33, as shown in FIG. 1. In addition to the above-described elements, the first application slave device 30A may include an input-output interface and a bus line for wired or wireless communication with devices other than the master device 20. The control circuit 31 has a similar configuration to the control circuit 21 of the master device 20. The control circuit 31 includes, for example, a processor 311 and a memory 312. The memory 312 includes, for example, RAM and ROM.

The control circuit 31 can extract the request command and the like by executing the decoding process on the packet acquired via the wireless communication circuit 32. The extracted request command is transmitted to the first application device 35A. Thus, the first application device 35A can execute the requested process (a response process such as acquiring and returning the requested data, an execution process of the requested process, or the like) based on the request command. For example, when the request command, which is included in the received packet, is a transmission request for the battery information, the first application device 35A detects the battery information of the corresponding battery stack and transmits the detected battery information to the control circuit 31. As a response to the request command, the control circuit 31 transmits the packet including the data, which is encrypted using the encryption information including the detected battery information, to the wireless communication circuit 32. In this case, the encryption process may not be executed.

The wireless communication circuit 32 includes a RF circuit (not shown) for wirelessly transmitting and receiving the packet. The wireless communication circuit 32, like the wireless communication circuit 22, has a transmission function and a receiving function. The wireless communication circuit 32 receives the packet transmitted from the master device 20 via the antenna 33 and demodulates the packet. The demodulated packet is transmitted to the control circuit 31. The wireless communication circuit 32 modulates the packet containing data transmitted from the control circuit 31 and transmits the packet to the master device 20 via the antenna 33. The wireless communication circuit 32 can add data necessary for the wireless communication, such as communication control information, to the transmission packet. The wireless communication circuit 32 may control data size, communication format, schedule, error detection, or the like of communication between the master device 20 and the first application slave device 30A. The control related to these communications may be performed by the control circuit 31. The antenna 33 converts electrical signals into radio waves and radiates the radio waves into space. The antenna 33 receives a electric wave propagating in space and converts the electric wave into an electric signal.

As described above, the first application control device 1 and the first application device 35A constituting the battery monitoring system utilize bidirectional wireless communication in the wireless communication system 10. The first application control device 1 acquires the battery information and the like required for the battery monitoring system from the first application device 35A.

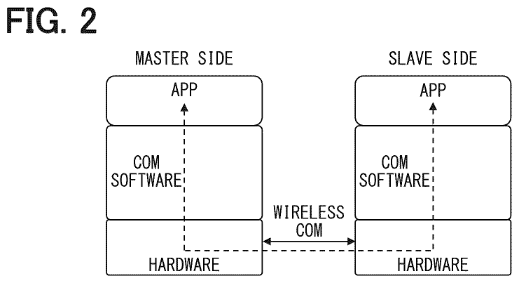

FIG. 2 is a schematic diagram showing the software and hardware configuration of various application systems. In FIG. 2, the “application” on the master side corresponds to, for example, the software of the first application control device 1. The “communication software” on the master side corresponds to the software executed by the control circuit 21 of the master device 20. The “hardware” on the master side corresponds to the wireless communication circuit 22. Moreover, the “application” on the slave side corresponds to, for example, the software of the first application device 35A. The “communications software” on the slave side corresponds to, for example, software executed by the control circuit 31 of the first application slave device 30A. The “hardware” on the slave side corresponds to, for example, the wireless communication circuit 32 of the first application slave device 30A.

In this embodiment, when an “application” on the slave side, for example, the first application device 35A, outputs a standby instruction, the “communication software” and “hardware” on the slave side, for example, the control circuit 31 and wireless communication circuit 32 of the first application slave device 30A, are configured to transition to the standby state and stop their respective operations. When the control circuit 31 and the wireless communication circuit 32 of the first application slave device 30A transition to the standby state, it becomes possible to reduce the power consumption in the first application slave device 30A.

Here, the above described various application systems may be required to acquire the latest data value necessary for each system via the wireless communication between the master device 20 and the slave devices 30A, 30B, 40A, 40B, 50A at each specific system period in order to execute monitoring, warning, or other processing depending on the situation at that time. The predetermined system period may vary from application system to application system. In general, when the data as a monitoring or warning target changes within a short period of time, the system period can be set to be shorter than when the data changes over a longer period of time. Furthermore, the greater the influence on vehicle driving and safety, the shorter the system period may be set. In other words, an application system that requires high reliability of data can have a shorter system period length set than an application system that is sufficient with low reliability.

In order for various application systems to acquire necessary data, the master device 20 and each of the slave devices 30A, 30B, 40A, 40B, and 50A execute the bidirectional wireless communication. The wireless communication is more prone to communication errors than the wired communication. Therefore, in this embodiment, it is determined that the master device 20 and each of the slave devices 30A, 30B, 40A, 40B, and 50A execute the wireless communication multiple times within the system period of the corresponding application system. This increases the probability that various application systems can acquire the latest data values for each system period.

The number of wireless communications per system period may be also different depending on the type of application system. For example, an application system that requires high reliability of data can set the larger number of wireless communications per system period than an application system that is sufficient with low reliability.

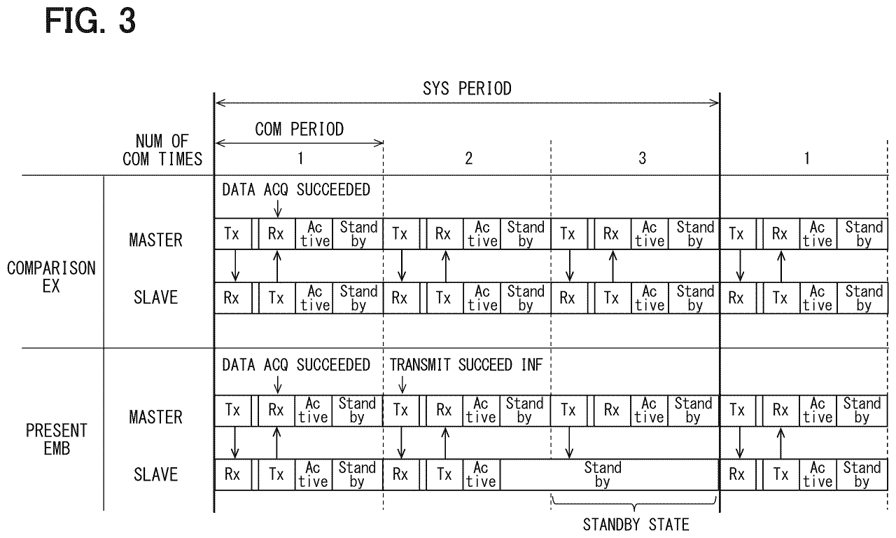

FIG. 3 is a diagram showing an example of the relationship between the system period and a communication period of the wireless communication between the master device 20 and the slave devices 30A, 30B, 40A, 40B, 50A.

FIG. 3 shows an example in which the wireless communication is executed three times within one system period. In the wireless communication in each communication period, first, the master device 20 transmits a packet including a request command. Each of the slave devices 30A, 30B, 40A, 40B, and 50A returns the requested data in response to receiving a packet including a request command.

Here, as shown in the “Comparison Example” in the upper part of FIG. 3, if the application system succeeds in acquiring the required data in the wireless communication in the first communication period, the application will have acquired the latest data in that system period. Therefore, as shown in the “Comparison Example” of FIG. 3, the slave devices 30A, 30B, 40A, 40B, and 50A are unlikely to need to transmit the data again in the subsequent communication period.

According to the wireless communication system 10 of the present embodiment, when the application system has successfully acquired the data in a predetermined number of wireless communications, the master device 20 is configured to transmit success information to the slave devices 30A, 30B, 40A, 40B, 50A. The slave devices 30A, 30B, 40A, 40B, and 50A are configured to transition to a standby state in response to receiving the success information, and to stop the remaining wireless communications of the multiple wireless communications. Thus, the application system can acquire the latest value of the data at each predetermined system period, while reducing the power consumption in the slave devices 30A<30B, 40A, 40B, 50A. As a result, when the slave devices 30A, 30B, 40A, 40B, and 50A operate using the power supplied from a battery, the operation time of the slave devices 30A, 30B, 40A, 40B, and 50A can be extended.

An example of a communication sequence in the wireless communication system 10 according to the present embodiment is shown in the “Embodiment” in the lower part of FIG. 3. In the “Embodiment” of FIG. 3, if the application system succeeds in acquiring the necessary data in the wireless communication in the first communication period, the success information is transmitted from the master device 20 in the wireless communication in the second communication period. Here, FIG. 3 shows an example in which the slave devices 30A, 30B, 40A, 40B, and 50A return an acknowledgement in response to receiving the success information. Alternatively, this acknowledgement may not be returned.

In the “Embodiment” of FIG. 3, since the success information is received in the wireless communication in the second communication period, the slave devices 30A, 30B, 40A, 40B, and 50A remain in the standby state in the third communication period. As a result, no request command is received from the master device 20, and no data is transmitted. In this manner, the slave devices 30A, 30B, 40A, 40B, and 50A stop operations related to transmission and reception.

FIG. 3 shows a communication sequence in which the master device 20 communicates with one of the slave devices 30A, 30B, 40A, 40B, and 50A. When the master device 20 communicates with multiple slave devices 30A, 30B, 40A, 40B, and 50A, for example, in each communication period, a communication period (sub-communication period) may be assigned to the multiple slave devices 30A, 30B, 40A, 40B, and 50A with which to communicate.

As described above, the wireless communication system 10 according to the present embodiment requires two communication periods for transmitting and receiving the data required by the application system and transmitting and receiving success information. Therefore, the slave devices 30A, 30B, 40A, 40B, and 50A can transition to the standby state from the third communication period at the earliest. Therefore, in this embodiment, the number of communication periods per system period is set to three or more.

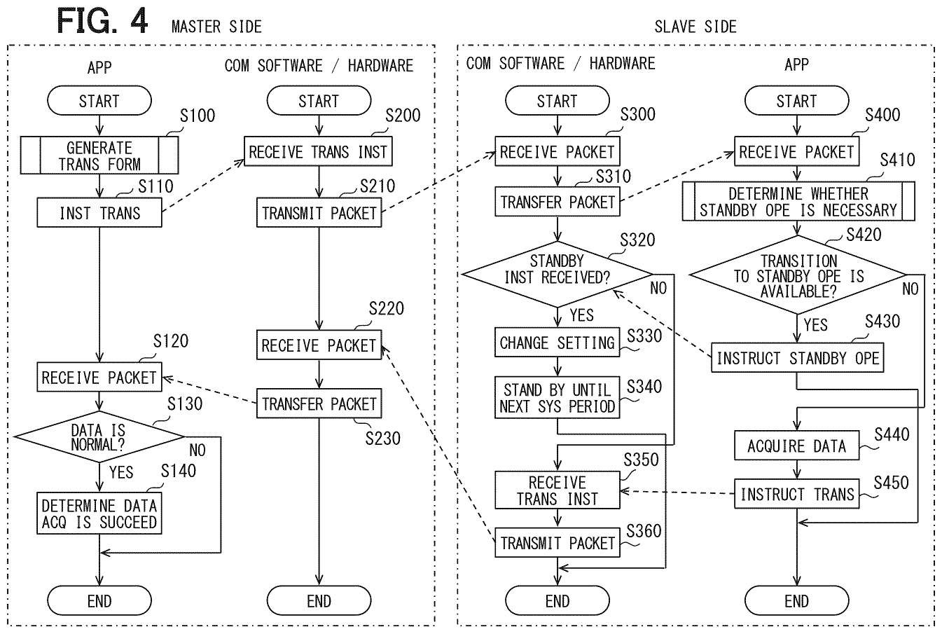

With referring to a flowchart in FIG. 4, an example of a process executed in an application system including a wireless communication system 10 will be explained.

The process illustrated in the flowchart of FIG. 4 is executed periodically, for example, at a predetermined communication period. Furthermore, when a plurality of application systems are installed in a vehicle, the process shown in the flowchart of FIG. 4 is executed in each of the application systems.

When the master device 20 and the slave devices 30A, 30B, 40A, 40B, and 50A execute the wireless communication according to, for example, the Bluetooth LE communication standard, a connection establishment process may be executed before executing the process shown in the flowchart of FIG. 4. In the connection establishment process, for example, the slave devices 30A, 30B, 40A, 40B, 50A execute an advertisement operation of transmitting an advertisement signal via an advertising communication channel. The master device 20 executes a scanning operation to scan for the advertisement signal. The communication channel for advertising includes a plurality of communication channels (for example, three in the case of Bluetooth LE). When the master device 20 receives an advertisement signal through one of the communication channels through a scanning operation, the master device 20 transmits a connection request to the slave device 30A, 30B, 40A, 40B, 50A that has transmitted the advertisement signal. When this connection request is received by the slave devices 30A, 30B, 40A, 40B, and 50A, a communication connection is established between the master device 20 and the slave devices 30A, 30B, 40A, 40B, and 50A.

After the communication connection is established, the master device 20 and the slave devices 30A, 30B, 40A, 40B, and 50A exchange connection information. In this exchange of the connection information, the master device 20 and the slave device 30A, 30B, 40A, 40B, 50A can exchange encryption information used for the data communication and execute a share process for sharing the initial information regarding frequency channel hopping. The initial information includes, for example, a hopping pattern or a function for hopping.

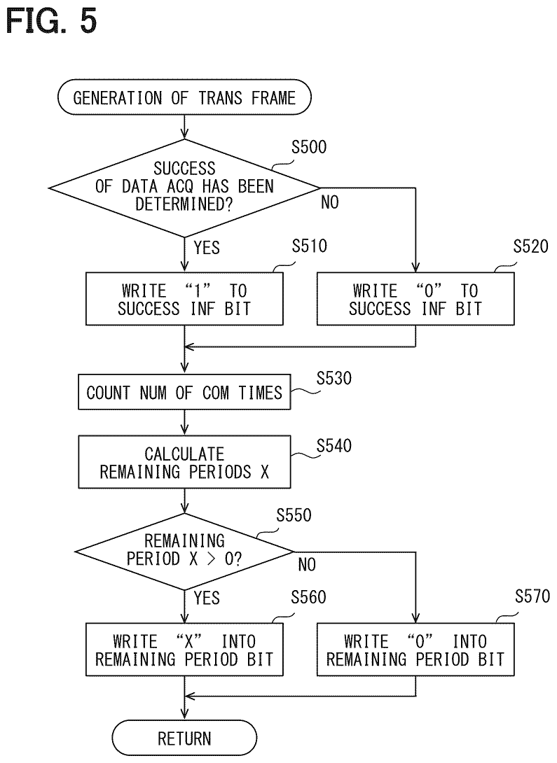

In step S100 of the flowchart in FIG. 4, an application on the master side (for example, the first application control device 1) executes a process of generating a transmission frame. An example of the details of the generation process of the transmission frame is shown in the flowchart of FIG. 5. The generation process of the transmission frame will be described with reference to a flowchart of FIG. 5.

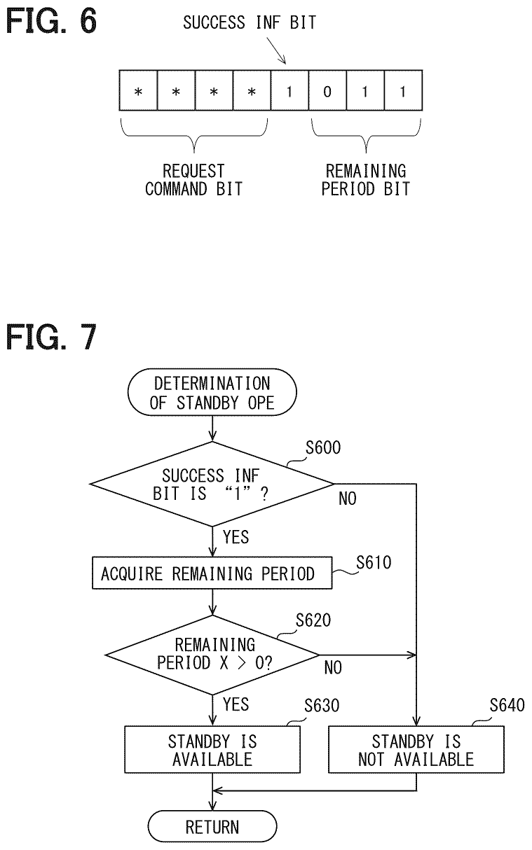

As described above, the application on the master side transmits a request command to the application side to request data required by the application system. In the generation process of the transmission frame, a transmission frame is generated that includes a request command as shown in FIG. 6, and further includes success information if data acquisition is successful in the master-side application, and further includes the number of remaining communication periods in which the slave devices 30A, 30B, 40A, 40B, and 50A can stop operating. The format of the transmission frame is not restricted to the example shown in FIG. 6. For example, it is possible for the master side to directly generate a packet to be transmitted to the slave devices 30A, 30B, 40A, 40B, and 50A without generating the transmission frame.

In step S500 of the flowchart in FIG. 5, the application on the master side determines whether the data acquisition has been successfully determined. The data acquisition success determination is executed in step S140 of the flowchart in FIG. 4, which will be described later. If it is determined that the data acquisition has been successful, the master-side application proceeds to the process of step S510. If it is determined that the data acquisition has not been successful, the master-side application proceeds to the process of step S520.

In step S510, the application on the master side writes “1” to the success information bit of the transmission frame, indicating that the data acquisition has been successful. In step S520, the application on the master side writes “0” to the success information bit of the transmission frame, indicating that the data acquisition has not been successful yet.

In step S530, the application on the master side counts the number of communications Ncnt which have been executed. For example, if it is the first communication period since the system period started, the number of communications Ncnt is counted as 1. In step S540, the application on the master side calculates the remaining period X, which is the number of remaining communication periods during which the slave devices 30A, 30B, 40A, 40B, and 50A can stop operating. For example, if the number of communication periods per system period is Nthr, the remaining period X can be calculated by the following Expression 1. The process in steps S530 and S540 corresponds to the calculation unit in the present embodiments.

X=Nthr−Ncnt−1 (Expression 1)

The reason for subtracting 1 is that in the next communication period, the master device 20 will transmit the success information to the slave devices 30A, 30B, 40A, 40B, and 50A, and so it is necessary to reduce the number of communication periods in which the slave devices 30A, 30B, 40A, 40B, and 50A can stop operating by that amount.

In step S550, the application on the master side determines whether the remaining period X is greater than zero. If it is determined that the remaining period X is greater than zero, the master-side application proceeds to the process of step S560. If it is determined that the remaining period X is equal to zero, the master-side application proceeds to the process of step S570.

In step S560, the application on the master side writes “X”, which is the calculated remaining period, to the remaining period bit of the transmission frame. In step S570, the application on the master side writes “0” to the remaining period bit of the transmission frame.

In the flowchart of FIG. 5, the remaining period X is calculated regardless of whether or not the data acquisition has been determined to be successful, and the remaining period X is written in the remaining period bit of the transmission frame. Here, only when it is determined that the data acquisition has been successful, the remaining period X may be calculated and the calculated remaining period X may be written in the remaining period bit. In this case, if it is not determined that the data acquisition has been successful, a certain value that has no is meaning as the remaining period, such as “0”, may be written in the remaining period bit. In the flowchart of FIG. 5, an example has been described in which the application on the master side counts up the number of communications Ncnt which have been executed. Here, the application on the master side may count down from the number of communication periods per system period Nthr, every time the communication is executed. In this case, the remaining period X can be acquired by subtracting 1 from the number of communication periods after the countdown.

The explanation is continued by returning to the flowchart of FIG. 4. In step S110, the application on the master side instructs the master side communication software/hardware (corresponding to the master device 20) to transmit the generated transmission frame to the corresponding slave devices 30A, 30B, 40A, 40B, and 50A.

In step S200, the master-side communication software/hardware receives a transmission instruction including a transmission frame from the master-side application. In step S210, the master side communication software/hardware generates a packet based on the transmission frame. Then, the communication software/hardware on the master side modulates the generated packet and transmits the modulated packet.

In step S300, the slave-side communication software/hardware (corresponding to the slave devices 30A, 30B, 40A, 40B, and 50A) demodulates and receives the packet t transmitted from the master-side communication software/hardware. In step S310, the communication software/hardware on the slave side transfers the received packet to the application on the slave side.

In step S400, the application on the slave side receives the transferred packet. Then, in step S410, the application on the slave side determines whether or not to transition to the standby state based on the success information bit included in the received packet. An example of the details of the standby allowability determination process for determining whether or not to transition to the standby state is shown in the flowchart of FIG. 7. The standby allowability determination process will be described with reference to a flowchart of FIG. 7.

Then, in step S600, the application on the slave side determines whether or not the value of the success information bit included in the received packet is “1”. If it is determined that the value of the success information bit is “1”, the slave side application proceeds to the process of step S610. If it is determined that the value of the success information bit is not “1”, the slave side application proceeds to the process of step S640.

Then, in step S610, the application on the slave side acquires the remaining period X based on the remaining period bit included in the received packet. In step S620, the application on the slave side determines whether the acquired remaining period X is greater than zero. If it is determined that the remaining period X is greater than zero, the slave-side application proceeds to the process of step S630. If it is determined that the remaining period X is equal to zero, the slave-side application proceeds to the process of step S640.

In step S630, the application on the slave side determines that transition to the standby state is allowable. In step S640, the application on the slave side determines that transition to the standby state is not allowable.

The explanation is continued by returning to the flowchart of FIG. 4. In step S420, the application on the slave side determines whether or not transition to the standby state is allowable based on the standby allowability determination process. When it is determined that transition to the standby state is allowable, the slave side application proceeds to step S430. When it is determined that transition to the standby state is not allowable, the slave side application proceeds to step S440.

In step S430, the application on the slave side outputs a standby instruction to the communication software/hardware on the slave side. At this time, the application on the slave side instructs the communication software/hardware on the slave side on the period for which the slave side communication software/hardware is in the standby state based on the remaining period X. This allows the communication software/hardware on the slave side to remain in a standby state until the start of the next system period. In addition, the application on the slave side may instruct the communication software/hardware on the slave side to transmit an acknowledgement to notify the master side that it has successfully received a packet with a success information bit of “1”.

In step S440, the application on the slave side acquires the data corresponding to the request command. In step S450, the application on the slave side instructs the communication software/hardware to transmit the acquired data to the master side.

In step S320, the slave side communication software/hardware determines whether or not a standby instruction has been received from the slave side application. If it is determined that a standby instruction has been received, the slave-side communication software/hardware proceeds to processing of step S330. On the other hand, if it is determined that a standby instruction has not been received, the slave-side communication software/hardware proceeds to processing of step S350.

In step S330, the slave side communication software/hardware changes the settings of the timer, configuration, and the like, in preparation for transition to the standby state. Then, in step S340, the slave side communication software/hardware transitions to a standby state until the start of the next system period.

In step S350, the communication software/hardware on the slave side receives a transmission instruction from the application on the slave side. In step S360, the communication software/hardware on the slave side modulates and transmits to the master side a packet including the data acquired by the application on the slave side.

In step S220, the communication software/hardware on the master side demodulates and receives the packet transmitted from the communication software/hardware on the slave side. In step S230, the communication software/hardware on the master side transfers the received packet to the application on the master side.

In step S120, the application on the master side receives the transferred packet. Then, in step S130, the application on the master side determines whether the data included in the received packet is normal. For example, the master application may store in advance a normal range of data values and determine that the acquired data is normal if the acquired data is disposed within the normal range, and anomaly if the acquired data is not disposed in the normal range. Furthermore, the application on the master side may determine that the acquired data is normal if the change from the previous data is disposed within a predetermined value, and anomaly if the change from the previous data is not disposed within a predetermined value.

Furthermore, the master-side application may also determine that the data included in the received packet is anomaly if, for example, the master-side communication software/hardware determines that the packet has not been received correctly based on an error detection code included in the received packet.

If it is determined that the data is normal i step S130, the master-side application proceeds to the process of step S140. In step S140, since the master-side application has succeeded in acquiring the data, the master side application determines that the data acquisition was successful. As described above, the result of the data acquisition success determination is referred to in the transmission frame generation process in step S100. On the other hand, if it is determined in step S130 that the data is anomaly, the application on the master side ends the process shown in the flowchart of FIG. 4 without determining whether the data acquisition was successful.

As described above, the slave devices 30A, 30B, 40A, 40B, and 50A are configured to transition to a standby state in response to receiving the success information from the master side, and to stop the remaining wireless communications of the multiple wireless communications. Here, in this embodiment, as shown in FIG. 3, even if the slave devices 30A, 30B, 40A, 40B, and 50A are in a standby state, the master device 20 maintains a state in which the master device 20 can communicate with the slave devices 30A, 30B, 40A, 40B, and 50A. This feature is to enable the application on the slave side (corresponding to application devices 35A, 35B, 45A, 55A) to transmit anomaly information to the master side when the application on the slave side detects an anomaly in any of the various sensors or an anomaly in its own operation, for example.

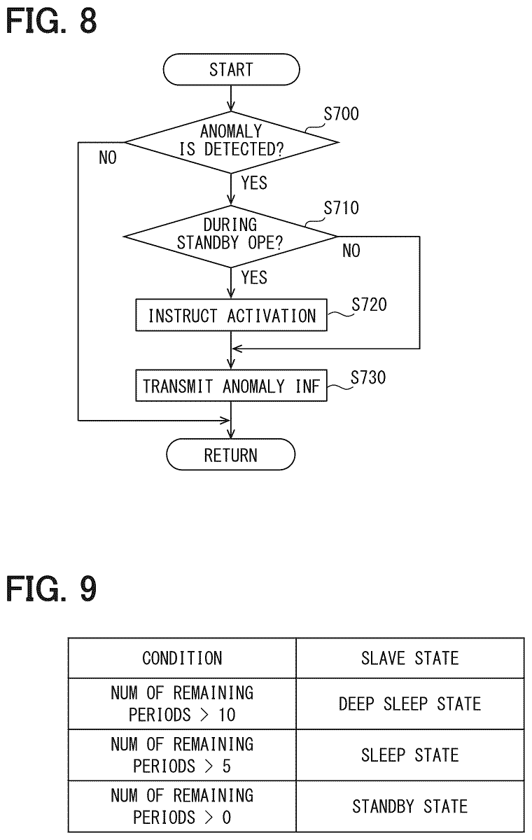

FIG. 8 is a flowchart showing an example of a process for transmitting to the master side when an application on the slave side detects an anomaly. In step S700, the slave-side application determines whether or not the slave-side application has detected a sensor anomaly or an anomaly in its own operation. If an anomaly is detected, the slave side application proceeds to the process of step S710. On the other hand, if no anomaly is detected, the slave side application ends the process shown in the flowchart of FIG. 8.

In step S710, it is determined whether the communication software/hardware on the slave side is in the standby state. When it is determined that the communication software/hardware on the slave side is in the standby state, the slave side application proceeds to step S720. On the other hand, if it is determined that the the communication software/hardware on the slave side is not in the standby state, the application on the slave side proceeds to the process of step S730.

In step S720, the application on the slave side outputs an activation instruction to the communication software/hardware on the slave side. As a result, the communication software/hardware on the slave side returns from a standby state to a state in which the wireless communication is executable. In step S730, the application on the slave side instructs the communication software/hardware on the slave side to transmit the anomaly information indicating the detected anomaly.

Although the preferred embodiments of the present disclosure have been described above, the present disclosure is not limited to the embodiments described above, and can be implemented with various modifications without departing from the gist of the present disclosure.

### (Modification 1)

In the above-described embodiment, when the slave-side application receives the success information from the master-side, the slave side application causes the slave-side communication software/hardware to transition to a standby state. In the standby state, the communication software/hardware on the slave side stops operating, so that the power consumption of the communication software/hardware on the slave side can be reduced. Here, the slave-side application may instruct the slave-side communication software/hardware to transition to a sleep state rather than to a standby state. In this sleep state, for example, the power supply to at least a part of the slave side control circuit 31 and the wireless communication circuit is stopped. This makes it possible to further reduce the power consumption of the communication software/hardware on the slave side.

### (Modification 2)

Whether the slave side application instructs the slave side communication software/hardware to transition to the standby state or the sleep state may be determined according to the number of remaining periods X. Specifically, the application on the slave side may instruct the state of the communication software/hardware on the slave side so that the power consumption of the communication software/hardware on the slave side decreases as the number of remaining periods X increases.

FIG. 9 is a diagram showing an example in which a slave-side communication software and hardware is instructed to transition to one of a standby state, a sleep state, and a deep sleep state depending on the number of times of remaining periods X. The range of circuits to which power is cut off differs between the sleep state and the deep sleep state. In the deep sleep state, the power supply to circuits is stopped to a wider range than in the sleep state. In this way, by switching the state of the communication software/hardware on the slave side in accordance with the remaining period X, the longer the remaining period X is, the greater the effect of reducing the power consumption can be obtained.

Here, while the power consumption decreases in the standby state, the sleep state, and the deep sleep state in this order, the time it takes for the slave side communication software/hardware to return to a communication-enabled state increases. From this viewpoint, when the remaining period X is short, it may be preferable to set the device to a standby state in which it takes a short time to return to a communication-enabled state, and when the remaining period X is longer than that, it may be preferable to set the device to a sleep state or a deep sleep state.

### (Modification 3)

In the above embodiment, an example has been described in which the application on the master side calculates the remaining period X, which is the number of remaining communication periods in which the communication software/hardware on the slave side can stop operating. Here, instead of the remaining period X, the application on the master side may calculate a stoppable time during which the communication software/hardware on the slave side can stop operating. The application on the master side can calculate the stoppable time during which the communication software/hardware on the slave side can stop operating from the number of remaining periods and the length of the communication period.

In this case, whether the slave side application instructs the slave side communication software/hardware to transition to the standby state or the sleep state may be determined according to the length of the stoppable time. Specifically, the application on the slave side may instruct the state of the communication software/hardware on the slave side so that the power consumption of the communication software/hardware on the slave side decreases as the length of the stoppable time increases.

### (Modification 4)

In the above embodiment and the modification 3, an example has been described in which the application on the master side calculates the remaining period X and the stoppable time in which the communication software/hardware on the slave side can stop operating. Here, it is also possible for the application on the slave side to calculate the remaining period X or the stoppable time during which the operation of the communication software/hardware on the slave side can be stopped.

### (Modification 5)

In the modifications 2 and 3, the application on the slave side determines whether to instruct the slave side communication software/hardware to transition to the standby state or the sleep state based on the remaining period X or the stoppable time. In addition, or instead, the slave-side application may determine whether to instruct the slave-side communication software/hardware to transition to a standby state or a sleep state depending on the state of the vehicle, which may include at least whether the vehicle is running or parked. Additionally, the application system may change the length of the system period depending on the state of the vehicle, which includes at least whether the vehicle is running or parked.

For example, if the application system is a battery monitoring system, when the vehicle is running, each battery stack of the assembled battery is charged and discharged by supplying power to the drive motor and by regenerating power using the regenerative motor. As a result, the voltage, current, temperature, and the like of each battery stack change from moment to moment. For this reason, when the vehicle is running, it may be preferable for the application system to shorten the system period in order to grasp the measurement values of each battery stack without delay. Furthermore, it may be preferable that the wireless communication system 10 is able to quickly recover from the stop operation state when the operation of the communication software/hardware on the slave side is stopped. Therefore, when the vehicle is running, it may be preferable that the application on the slave side instructs the slave side to transition to a standby state when the slave side communication software/hardware is able to stop operating.

On the other hand, if the application system is a battery monitoring system, when the vehicle is stopped or parked, the change in the state of each battery stack is small, so there is little need to acquire the battery information frequently compared to when the vehicle is running. Therefore, it may be preferable for the application system to have a system period longer than the system period when the vehicle is running. Furthermore, when the wireless communication system 10 stops the operation of the communication software/hardware on the slave side, it may be preferable to obtain a greater power reduction effect by stopping the operation. Therefore, when the vehicle is stopped or parked, it may be preferable that the application on the slave side instructs the slave side to transition to a sleep state or a deep sleep state when the slave side communication software/hardware is able to stop operating.

Furthermore, if the application system is a tire pressure monitoring system, the air pressure of the tires as a monitoring target affects the running state of the tires while the vehicle is running. Therefore, when the vehicle is running, it may be preferable for the application system to shorten the system period. Furthermore, it may be preferable that the wireless communication system 10 is able to quickly recover from the stop operation state when the operation of the communication software/hardware on the slave side is stopped. Therefore, when the vehicle is running, it may be preferable that the application on the slave side instructs the slave side to transition to a standby state when the slave side communication software/hardware is able to stop operating.

On the other hand, if the application system is a tire pressure monitoring system, when the vehicle is parked or stopped, the tires do not rotate, so there is little need to frequently acquire tire pressures. Therefore, it may be preferable for the application system to have a system period longer than the system period when the vehicle is running. Furthermore, when the wireless communication system 10 stops the operation of the communication software/hardware on the slave side, it may be preferable to obtain a greater power reduction effect by stopping the operation. Therefore, when the vehicle is stopped or parked, it may be preferable that the application on the slave side instructs the slave side to transition to a sleep state or a deep sleep state when the slave side communication software/hardware is able to stop operating.

Furthermore, in the case where the application system is a smart entry system, it may be preferable that the master device 20 of the wireless communication system 10 communicates with the smart key more frequently while the vehicle is parked, so that when a user carrying the smart key approaches the vehicle, the distance to the smart key, and the like can be detected with high accuracy. Therefore, when the vehicle is parked and stopped and a user carrying a smart key approaches the vehicle, it may be preferable for the application system to shorten the system period. Furthermore, it may be preferable that the wireless communication system 10 is able to quickly recover from the stop operation state when the operation of the communication software/hardware on the slave side is stopped. Therefore, when the vehicle is parked and a user carrying a smart key approaches the vehicle, it may be preferable that when the slave side communication software/hardware is able to stop operating, the slave side application instructs the slave side to transition to a standby state.

On the other hand, when the application system is a smart entry system, after the vehicle starts to travel, the smart key is inside the vehicle compartment, so there is little need to communicate with the smart key frequently. Therefore, it may be preferable for the application system to have a system period longer than the system period when the vehicle is parked. Furthermore, when the wireless communication system 10 stops the operation of the communication software/hardware on the slave side, it may be preferable to obtain a greater power reduction effect by stopping the operation. Therefore, after the vehicle starts travelling, it may be preferable that the application on the slave side instructs the slave side to transition to a sleep state or a deep sleep state when the slave side communication software/hardware is able to stop operating.

### (Modification 6)

In modification 5, the length of the system period is changed depending on the state of the vehicle, which includes at least when the vehicle is running and when the vehicle is parked, and the state when the communication software/hardware on the slave side can stop operating (i.e., the standby state or the sleep state) is changed. Furthermore, the wireless communication system 10 may change the number of wireless communications executed within a system period depending on the state of the vehicle, which includes at least whether the vehicle is running or parked. For example, it may be preferable to change the number of wireless communications when the application system shortens the system period so that the number of wireless communications executed within the system period is greater than the number of wireless communications executed within the system period when the application system lengthens the system period. This is because, in general, when the system period is shortened, higher data reliability is required.

The features described in the above-mentioned embodiments and each modifications can be implemented in combination with the features described in other embodiments and other modifications, unless it is technically impossible to combine them.

Further, the device, the system and the method therefor which have been described in the present disclosure may be also realized by a dedicated computer which constitutes a processor programmed to execute one or more functions concretized by computer programs. The device and the method described in the present disclosure may be also implemented by a dedicated hardware logic circuit. Further, the device and the method described in the present disclosure may be also implemented by one or more dedicated computers which are constituted by combinations of a processor for executing computer programs and one or more hardware logic circuits. The processor may be any type of an arithmetic core such as a CPU, an MPU, a GPU, a DFP (i.e., Data Flow Processor) or the like. For example, some or all of the functions of the processor may be implemented as hardware. Some or all of the functions of the processor may be realized using any of a system-on-chip (i.e., SoC), an integrated circuit (i.e., IC), and a field-programmable gate array (i.e., FPGA).

This specification discloses multiple technical features described in multiple items listed below. Some items may be described in multiple dependent form to refer to more than one preceding items in the alternative. Further, some items may be written in multiple dependent form, referencing multiple items that include other items in multiple dependent form. These items described in a multiple dependent form define multiple technical features. Furthermore, the technical features described in the following items also apply to a control method for a wireless communication system.

### (Technical Feature 1)

A wireless communication system is used for acquiring data required by at least one predetermined application system. The wireless communication system includes: at least one master node; and at least one slave node. The at least one master node and the at least one slave node execute bidirectional wireless communication. The at least one slave node transmits the data to the at least one master node. The at least one predetermined application system is required to acquire a latest value of the data at each predetermined system period. The at least one master node and the at least one slave node are configured to execute the bidirectional wireless communication a plurality of times within the predetermined system period. When the at least one predetermined application system has successfully acquired the data in a predetermined number of the plurality of times of the bidirectional wireless communication, the at least one master node transmits success information to the at least one slave node. In response to receiving the success information, the at least one slave node stops a remaining number of the plurality of times of the bidirectional wireless communication.

### (Technical Feature 2)

In the wireless communication system according to the technical feature 1, the at least one master node and the at least one slave node are configured to execute the bidirectional wireless communication three or more times within the predetermined system period.

### (Technical Feature 3)

In the wireless communication system according to the technical feature 1 or 2, the at least one slave node operates using power supplied from a battery.

### (Technical Feature 4)

In the wireless communication system according to any one of the technical features 1 to 3, the at least one master node has a calculation unit (S530, S540) that calculates a numerical number of times of the bidirectional wireless communication or a stoppable chronological time during which the bidirectional wireless communication can be stopped in the at least one slave node. The at least one master node transmits to the at least one slave node, together with the success information, the numerical number of times of the bidirectional wireless communication or the stoppable chronological time during which the bidirectional wireless communication can be stopped in the at least one slave node. The at least one slave node stops the bidirectional wireless communication according to the numerical number of times of the bidirectional wireless communication or the stoppable chronological time that has received by the at least one slave node.

### (Technical Feature 5)

In the wireless communication system according to the technical feature 4, the calculation unit counts the numerical number of times of the bidirectional wireless communication executed between the at least one master node and the at least one slave node, and calculates, based on a counted numerical number of times of the bidirectional wireless communication, the numerical number of times of the bidirectional wireless communication or the stoppable chronological time during which the bidirectional wireless communication can be stopped in the at least one slave node.

### (Technical Feature 6)

In the wireless communication system according to any one of the technical features 1 to 5, when the at least one slave node stops the bidirectional wireless communication, the at least one slave node transitions to one of a plurality of low power consumption states having different power consumptions based on the numerical number of times of the bidirectional wireless communication or the stoppable chronological time during which the bidirectional wireless communication can be stopped in the at least one slave node.

### (Technical Feature 7)

In the wireless communication system according to the technical feature 6, the more the numerical number of times of the bidirectional wireless communication during which the bidirectional wireless communication can be stopped in the at least one slave node, or the longer the stoppable chronological time during which the bidirectional wireless communication can be stopped in the at least one slave node, the lower the low power consumption state to which the at least one slave node transitions.

### (Technical Feature 8)

In the wireless communication system according to any one of the technical features 1 to 7, the at least one master node maintains in a state capable of executing the bidirectional wireless communication with the at least one slave node even while the at least one slave node has stopped the bidirectional wireless communication.

### (Technical Feature 9)

In the wireless communication system according to the technical feature 8, the at least one slave node cancels stopping of the bidirectional wireless communication and notifies the at least one master node of an occurrence of an anomaly if the anomaly that should be notified to the at least one master node occurs while the bidirectional wireless communication is stopped.

### (Technical Feature 10)

In the wireless communication system according to any one of the technical features 1 to 9, the at least one predetermined application system is mounted in a vehicle.

### (Technical Feature 11)

In the wireless communication system according to the technical feature 10, when the at least one slave node stops the bidirectional wireless communication, the at least one slave node transitions to one of a plurality of low power consumption states having different power consumptions based on a state of the vehicle including at least when the vehicle is running and when the vehicle is parked.

### (Technical Feature 12)

In the wireless communication system according to the technical feature 10 or 11, a length of the predetermined system period changes depending on a state of the vehicle including at least when the vehicle is running and when the vehicle is parked.

### (Technical Feature 13)

In the wireless communication system according to any one of the technical features 10 to 12, the plurality of times of the bidirectional wireless communication executed within the predetermined system period changes depending on a state of the vehicle including at least when the vehicle is running and when the vehicle is parked.

### (Technical Feature 14)

In the wireless communication system according to any one of the technical features 10 to 13, the at least one predetermined application system includes a plurality of application systems. The vehicle is equipped with the plurality of application systems. At least one of a length of the predetermined system period and the plurality of times of the bidirectional wireless communication within the predetermined system period is different among the plurality of application systems.

### (Technical Feature 15)

In the wireless communication system according to the technical feature 14, one of the plurality of application systems which requires a high reliability of the data has at least one of a shorter length of the predetermined system period and the plurality of a larger times of the bidirectional wireless communication within the predetermined system period, compare with another one of the plurality of application systems for which a low reliability is sufficient.

### (Technical Feature 16)

In the wireless communication system according to any one of the technical features 1 to 15, the at least one master node and the at least one slave node executes the bidirectional wireless communication using an encrypted packet.

The reference number 1 indicates a first application control device, the reference number 2 indicates a second application control device, the reference number 3 indicates a third application control device, the reference number 10 indicates a wireless communication system, the reference number 20 indicates a master device, the reference number 21 indicates a control circuit, the reference number 22 indicates a wireless communication circuit, the reference number 23 indicates an antenna, the reference numbers 30A and 30B indicate first application slave devices, the reference number 31 indicates a control circuit, the reference number 32 indicates a wireless communication circuit, the reference number 33 indicates an antenna, the reference numbers 35A and 35B indicate first application devices, the reference numbers 40A and 40B indicate second application slave devices, the reference number 45A indicates a second application device, the reference number 50A indicates a third application slave device, the reference number 55A indicates a third application device, and the reference number 100 indicates an in-vehicle system.

In the present disclosure or the claims, the term “processor” may refer to a single hardware processor or several hardware processors that are configured to execute processing defined by computer program code (i.e., one or more instructions of a computer program) by sequentially reading the computer program code included in a computer program. In other words, a “processor” is a hardware device that executes one or more program processes. Therefore, the computer program code can be considered software that defines the processing of the processor according to its content. The “processor” may be a general-purpose or specific-purpose processor, such as, CPU (Central Processing Unit), a microprocessor, GPU (Graphics Processing Unit) and DFP (Data Flow Processor), but is not limited to these examples.

In the present disclosure or the claims, the term “memory” is a non-transitory tangible storage medium and may refer to a single or several hardware memories configured to store computer program code and/or data in a manner accessible by the processor. The “memory” may be implemented using any suitable memory technology, such as SRAM (Static Random-access Memory), SDRAM (Synchronous Dynamic RAM), nonvolatile/flash memory, or other types of memory. The computer program code that constitutes the program is stored on the memory and, when executed by a processor, causes the processor to realize the various functions described above.

In the present disclosure or the claims, the term “circuit” refers to a single hardware logic circuit or several hardware logic circuits (in other words, “circuitry”) that are configured to execute specific processing defined based on a pre-designed circuit configuration. In other words (and in contrast to the “processor”), the term “circuit” in the present disclosure or the claims refers to a hardware device that executes specific processing based on a circuit configuration, not processing defined by software such as the above-described computer program code. For instance, “circuit” may include a custom IC (Integrated Circuit) such as ASIC (Application Specific Integrated Circuit) or FPGA (Field Programmable Gate Array) designed using a hardware description language (HDL). That is, the term “circuit” in the present disclosure or the claims includes all hardware circuits except the above-described processor that executes processing by reading computer program code.

In the present disclosure or the claims, the phrase “at least one of a circuit and a processor” should be interpreted disjunctively (logical OR) and should not be interpreted as at least one circuit and at least one processor. Therefore, in the present disclosure or the claim, “at least one of a circuit and a processor is configured to cause a wireless communication system to execute functions” includes the case where only the circuit causes a wireless communication system to execute all the functions. Additionally, “at least one of a circuit and a processor is configured to cause a wireless communication system to execute functions” includes the case where only the processor causes v to execute all the functions. Furthermore, “at least one of a circuit and a processor is configured to cause v to execute functions” includes the case where the circuit causes a wireless communication system to execute some of the functions and the processor causes a wireless communication system to execute the remaining functions. In the last case, for instance, if a wireless communication system executes functions A to C, functions A and B may be implemented by the circuit, and the remaining function C may be implemented by the processor.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A wireless communication system for acquiring data required by at least one predetermined application system, the wireless communication system comprising:
at least one master node having at least one of (i) a circuit and (ii) a processor with a memory storing computer program code executable by the processor; and
at least one slave node having at least one of (i) another circuit and (ii) another processor with another memory storing computer program code executable by the processor, wherein:
the at least one master node and the at least one slave node execute bidirectional wireless communication;
the at least one slave node transmits the data to the at least one master node;
the at least one predetermined application system is required to acquire a latest value of the data at each predetermined system period;
the at least one master node and the at least one slave node are configured to execute the bidirectional wireless communication a plurality of times within the predetermined system period;
when the at least one predetermined application system has successfully acquired the data in a predetermined number of the plurality of times of the bidirectional wireless communication, the at least one master node transmits success information to the at least one slave node; and
in response to receiving the success information, the at least one slave node stops a remaining number of the plurality of times of the bidirectional wireless communication.

2. The wireless communication system according to claim 1, wherein:
the at least one master node and the at least one slave node are configured to execute the bidirectional wireless communication three or more times within the predetermined system period.

3. The wireless communication system according to claim 1, wherein:
the at least one slave node operates using power supplied from a battery.

4. The wireless communication system according to claim 1, wherein:
the at least one master node has a calculation unit that calculates a numerical number of times of the bidirectional wireless communication or a stoppable chronological time during which the bidirectional wireless communication can be stopped in the at least one slave node;
the at least one master node transmits to the at least one slave node, together with the success information, the numerical number of times of the bidirectional wireless communication or the stoppable chronological time during which the bidirectional wireless communication can be stopped in the at least one slave node; and
the at least one slave node stops the bidirectional wireless communication according to the numerical number of times of the bidirectional wireless communication or the stoppable chronological time that has received by the at least one slave node.

5. The wireless communication system according to claim 4, wherein:
the calculation unit counts the numerical number of times of the bidirectional wireless communication executed between the at least one master node and the at least one slave node, and calculates, based on a counted numerical number of times of the bidirectional wireless communication, the numerical number of times of the bidirectional wireless communication or the stoppable chronological time during which the bidirectional wireless communication can be stopped in the at least one slave node.

6. The wireless communication system according to claim 1, wherein:
when the at least one slave node stops the bidirectional wireless communication, the at least one slave node transitions to one of a plurality of low power consumption states having different power consumptions based on a numerical number of times of the bidirectional wireless communication or a stoppable chronological time during which the bidirectional wireless communication can be stopped in the at least one slave node.

7. The wireless communication system according to claim 6, wherein:
the more the numerical number of times of the bidirectional wireless communication during which the bidirectional wireless communication can be stopped in the at least one slave node, or the longer the stoppable chronological time during which the bidirectional wireless communication can be stopped in the at least one slave node, the lower the low power consumption state to which the at least one slave node transitions.

8. The wireless communication system according to claim 1, wherein:
the at least one master node maintains in a state capable of executing the bidirectional wireless communication with the at least one slave node even while the at least one slave node has stopped the bidirectional wireless communication.

9. The wireless communication system according to claim 8, wherein:
the at least one slave node cancels stopping of the bidirectional wireless communication and notifies the at least one master node of an occurrence of an anomaly if the anomaly that should be notified to the at least one master node occurs while the bidirectional wireless communication is stopped.

10. The wireless communication system according to claim 1, wherein:
the at least one predetermined application system is mounted in a vehicle.

11. The wireless communication system according to claim 10, wherein:
when the at least one slave node stops the bidirectional wireless communication, the at least one slave node transitions to one of a plurality of low power consumption states having different power consumptions based on a state of the vehicle including at least when the vehicle is running and when the vehicle is parked.

12. The wireless communication system according to claim 10, wherein:
a length of the predetermined system period changes depending on a state of the vehicle including at least when the vehicle is running and when the vehicle is parked.

13. The wireless communication system according to claim 10, wherein:
the plurality of times of the bidirectional wireless communication executed within the predetermined system period changes depending on a state of the vehicle including at least when the vehicle is running and when the vehicle is parked.

14. The wireless communication system according to claim 10, wherein:
the at least one predetermined application system includes a plurality of application systems;
the vehicle is equipped with the plurality of application systems; and
at least one of a length of the predetermined system period and the plurality of times of the bidirectional wireless communication within the predetermined system period is different among the plurality of application systems.

15. The wireless communication system according to claim 14, wherein:
one of the plurality of application systems which requires a high reliability of the data has at least one of a shorter length of the predetermined system period and the plurality of a larger times of the bidirectional wireless communication within the predetermined system period, compare with another one of the plurality of application systems for which a low reliability is sufficient.

16. The wireless communication system according to claim 1, wherein:
the at least one master node and the at least one slave node executes the bidirectional wireless communication using an encrypted packet.

17. A method for controlling a wireless communication system which is used for acquiring data required by at least one predetermined application system,
the wireless communication system including at least one master node and at least one slave node,
the at least one master node and the at least one slave node executing bidirectional wireless communication,
the at least one slave node transmitting the data to the at least one master node,
the at least one predetermined application system being required to acquire a latest value of the data at each predetermined system period,
the at least one master node and the at least one slave node being configured to execute the bidirectional wireless communication a plurality of times within the predetermined system period,
the method for controlling the wireless communication system comprising:
transmitting success information from the at least one master node to the at least one slave node when the at least one predetermined application system has successfully acquired the data in a predetermined number of the plurality of times of the bidirectional wireless communication; and
stopping a remaining number of the plurality of times of the bidirectional wireless communication by the at least one slave node in response to receiving the success information.

18. A wireless communication system for acquiring data required by at least one predetermined application system, the wireless communication system comprising:
at least one master node; and
at least one slave node, wherein:
the at least one master node and the at least one slave node execute bidirectional wireless communication;
the at least one slave node transmits the data to the at least one master node;
the at least one predetermined application system is required to acquire a latest value of the data at each predetermined system period;
the at least one master node and the at least one slave node are configured to execute the bidirectional wireless communication a plurality of times within the predetermined system period;
when the at least one predetermined application system has successfully acquired the data in a predetermined number of the plurality of times of the bidirectional wireless communication, the at least one master node transmits success information to the at least one slave node; and
in response to receiving the success information, the at least one slave node stops a remaining number of the plurality of times of the bidirectional wireless communication.
